(19) United States
(12) Patent Application Publication
(10) Pub. No.: US 2012/0151350 A1
(43) Pub. Date: Jun. 14, 2012

(54) Synthesis of a Linear Narrative from Search Content

(75) Inventors: Vijay Mital, Kirkland, WA (US); Oscar E. Murillo, Redmond, WA (US); Darryl E. Rubin, Duvall, WA (US); Colleen G. Estrada, Medina, WA (US)

(73) Assignee: MICROSOFT CORPORATION, Redmond, WA (US)

(21) Appl. No.: 12/965,857

(22) Filed: Dec. 11, 2010

(51) Int. Cl. G06F 3/01

(52) U.S. Cl. 715/730

(57) ABSTRACT

The subject disclosure is directed towards automatically synthesizing content found via one or more searches into a linear narrative such as a slideshow and/or other audiovisual presentation, for playback to a user. A model in conjunction with user input parameters may assist in obtaining the search content, comprising content objects. The model applies rules, constraints and/or equations to generate a plan comprising plan objects, and a content synthesizer processes the plan objects into the linear narrative. The user may interact to change the input parameters and/or the set of plan objects, resulting in a modified narrative being re-synthesized for playback.

### CROSS-REFERENCE TO RELATED APPLICATIONS

The present application is related to copending U.S. patent applications entitled “Addition of Plan-Generation Models and Expertise by Crowd Contributors” (attorney docket no. 330929.01), “Immersive Planning of Events Including Vacations” (attorney docket no. 330931.01), and “Using Cinematographic Techniques for Conveying and Interacting with Plan Sagas” (attorney docket no. 331022.01), each assigned to the assignee of the present application, filed concurrently herewith and hereby incorporated by reference.

### BACKGROUND

Planning something like a vacation, conference or wedding is difficult, as there are enormous amounts of variables, options, goals and other factors that can be considered when making the plan. For example, a wedding may require a site for the ceremony, a site for the reception, bridesmaid's dresses, available hotel accommodations for out of town visitors, and so forth, which need to be considered in view of factors such as cost, timing, proximity and so forth.

A person planning something along these lines may search the Internet to help get ideas and to start narrowing down the possible choices. However, the amount of content returned for a search can be overwhelming, and many times much of it is irrelevant or impractical to use. Further, while a human can recognize a relationship between the diverse concepts related to a wedding, such as reception sites and bridesmaid's dresses, search engines generally do not. Thus, multiple searches typically need to be performed to find desired content.

To help the user, images returned from a search may be arranged in galleries; content may be sorted based upon date, time, and tags, for example. Filtering and other narrowing techniques such as revised searches may be used to reduce the amount of content. However, even if the user is skilled in navigating galleries and using such techniques, it can still be very difficult to make sense of all the remaining content. Moreover, the remaining content for one diverse concept (e.g., bridesmaid dresses) is not organized or arranged relative to the content found for other concepts (e.g., hotels).

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology (e.g., provided by a web service) by which a linear narrative (e.g., a slideshow and/or audiovisual clip or clips) is synthesized from search content and played to a user. A search mechanism provides content objects (e.g., images, video clips, audio tracks and so forth) based on one or more searches. A content synthesizer processes selected content objects into a linear narrative, which the objects are selected based on rules, constraints and/or equations. A narrative playback mechanism outputs the linear narrative.

In one implementation, the rules, constraints and/or equations are built into a model which, based on user input parameters and/or goals, generates a plan comprising plan objects. The model may direct the search mechanism to find content objects, from which the plan objects are selected. The plan objects are synthesized into the linear narrative.

In one implementation, the user may interact to change the set of plan objects into a different set of plan objects, which results in a modified narrative being re-synthesized for playback. The user may also interact to change the input parameters and/or goals, whereby the model regenerates a modified plan with a different set of plan objects, and/or modified portions of objects, similarly resulting in a modified narrative being re-synthesized for playback. As used herein, a “linear” narrative may not necessarily be entirely linear, e.g., it may include a non-linear portion or portions such as branches and/or alternatives, e.g., selected according to user interaction and/or other criteria.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components for producing a linear narrative of search content.

FIG. 2 is a flow diagram representing example steps for presenting a linear narrative of search content to a user.

FIG. 3 is a flow diagram representing example steps for synthesizing content into a linear narrative.

FIG. 4 is a block diagram representing exemplary non-limiting networked environments in which various embodiments described herein can be implemented.

FIG. 5 is a block diagram representing an exemplary non-limiting computing system or operating environment in which one or more aspects of various embodiments described herein can be implemented.

### DETAILED DESCRIPTION

Various aspects of the technology described herein are generally directed towards providing a user experience that presents search content, including diverse search content, in a way that is easy for the user to follow and comprehend. In general, this is accomplished by automatically synthesizing various information into a linear narrative (or a narrative that can be experienced in a linear manner). The linear narrative may be in the form of a slideshow of images, for example, and/or an audiovisual experience comprising images, video, audio, text, animations and/or graphics.

As will be understood, the synthesized linear narrative allows the user to experience possibly diverse concepts in a logical manner, such as in a general time order. Moreover, the user may interact with the narrative's data, such as to remove a particular image, select a particular hotel, and so forth. Any such change re-synthesizes the narrative such that the narrative thereafter reflects that change.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and presenting searched content found in searches in general.

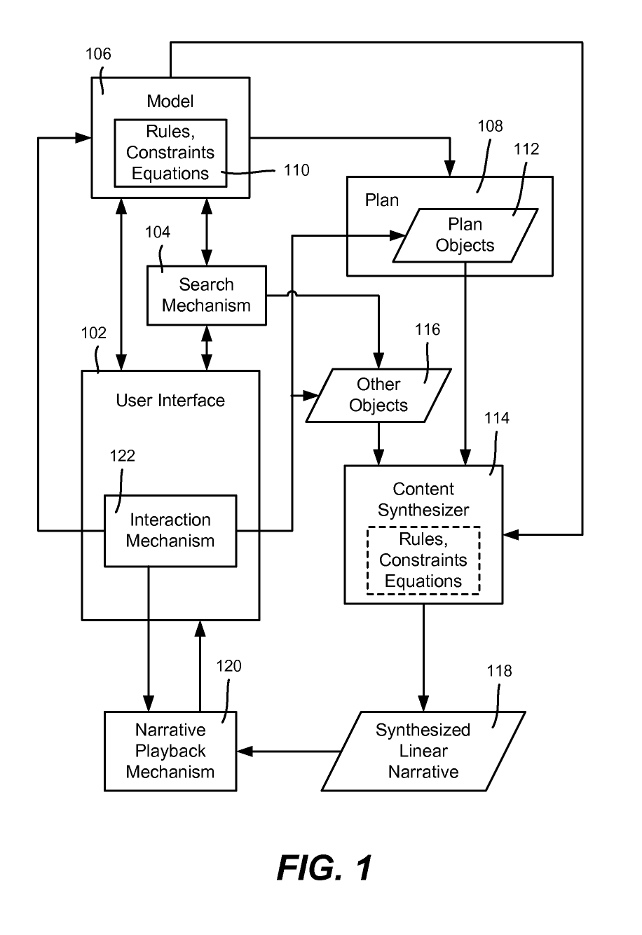

FIG. 1 shows example components for synthesizing and presenting such a narrative. In general, a user interacts through a user interface 102 to provide search terms or the like to a search mechanism 104, and/or to select a model 106 and provide input to the model 106 in order to generate a plan 108. As shown in FIG. 1, a single user interface 102 is shown, however it is understood that any component may have its own user interface capabilities, or may share a user interface with another component. Indeed, the components shown in FIG. 1 are only examples; any component exemplified in FIG. 1 may be combined with any other component or components, or further separated into subcomponents.

There may be many models from which a user may select, such as described in the aforementioned U.S. patent application “Addition of Plan-Generation Models and Expertise by Crowd Contributors.” For example, one user may be contemplating a skiing vacation, whereby that user will select an appropriate model (from possibly many skiing vacation models), while another user planning a beach wedding will select an entirely different model.

Each such model such as the model 106 includes rules, constraints and/or equations 110 for generating the relevant plan 108, as well as for generating other useful devices such as a schedule. For example, for a “Tuscany vacation” model, a rule may specify to select hotels based upon ratings, and a constraint may correspond to a total budget. An equation may be that the total vacation days equal the number of days in the Tuscany region plus the number of days spent elsewhere; e.g., if the user chooses a fourteen day vacation, and chooses to spend ten days in Tuscany, then four days remain for visiting other locations, (total days=Tuscany days+other days).

The selected model 106 may generate separate searches for a concept. By way of the “beach wedding” example, the selected model 106 may be pre-configured to generate searches for beaches, water, oceanfront views, weddings, and so forth to obtain beach-related and wedding-related search content (objects). The model 106 may also generate searches for bridesmaid dresses, hotels, wedding ceremonies, wedding receptions, beach wedding ceremonies, beach wedding receptions and so forth to obtain additional relevant objects. Additional details about models and plans are described in the aforementioned related U.S. patent applications, and in U.S. patent application Ser. No. 12/752,961, entitled “Adaptive Distribution of the Processing of Highly Interactive Applications,” hereby incorporated by reference.

To develop the plan 108, the model 106 applies the rules, constraints and/or equations 110 to balance parameters and goals input by the user, such as budgets, locations, travel distances, types of accommodation, types of dining and entertainment facilities used, and so forth. The content that remains after the model 106 applies the rules, constraints and/or equations 110 comprise plan objects 112 that are used in synthesizing the narrative. Note that non-remaining search content need not be discarded, but rather may be cached, because as described below, the user may choose to change their parameters and goals, for example, or change the set of objects. With changes to the set of plan objects, the linear narrative is re-synthesized. With changes to the parameters and goals, (and/or to the set of plan objects), the search content is processed according to the rules, constraints and/or equations 110 in view of the changes to determine a different set of plan objects 112, and the linear narrative re-synthesized.

The search mechanism 104 includes technology (e.g., a search engine or access to a search engine) for searching the web and/or private resources for the desired content objects, which may include images, videos, audio, blog and tweet entries, reviews and ratings, location postings, and other signal captures related to the plan objects 112 contained within a generated plan 108. For example, objects in a generated plan related to a vacation may include places to go to, means of travel, places to stay, places to see, people to see, and actual dining and entertainment facilities. Any available information may be used in selecting and filtering content, e.g., GPS data associated with a photograph, tags (whether by a person or image recognition program), dates, times, ambient light, ambient noise, and so on. Language translation may be used, e.g., a model for “traditional Japanese wedding” may search for images tagged in the Japanese language so as to not be limited to only English language-tagged images. Language paraphrasing may be used, e.g., “Hawaiian beach wedding” may result in a search for “Hawaiian oceanfront hotels,” and so forth.

Note that a user may interact with the search mechanism 104 to obtain other objects, and indeed, the user may obtain the benefit of a linear narrative without the use of any plan, such as to have a virtual tour automatically synthesized from various content (e.g., crowd-uploaded photographs) for a user who requests one of a particular location. For example, a user may directly interact with the search mechanism 104 to obtain search results, which may then be used to synthesize a linear narrative such as using default rules. A user may also provide such other objects to a model for consideration in generating a plan, such as the user's own photographs and videos, a favorite audio track, and so on, which the model may be configured to use when generating plan objects.

The content synthesizer 114 comprises a mechanism for synthesizing the content (plan objects 112 and/or other objects 116 such as a personal photograph) into a linear narrative 118. To this end, the content synthesizer 114 may segue multiple video clips and/or images, (e.g., after eliminating any duplicated parts). The content synthesizer 114 may splice together videos shot from multiple vantage points, so as to expand or complete the field of view (i.e. videosynth), create slideshows, montages, collages of images such as photographs or parts of photographs, splice together photographs shot from multiple vantage points so as to expand or complete the field of view or level of detail (i.e. photosynths). Other ways the content synthesizer 114 may develop the linear narrative is by extracting objects (people, buildings, 2D or 3D artifacts) from photographs or video frames and superimposing or placing them in other images or videos, by creating audio fragments from textual comments (via a speech-to-text engine) and/or from automatically-derived summaries/excerpts of textual comments, overlaying audio fragments as a soundtrack accompanying a slideshow of images or video, and so forth. Note that each of these technologies exists today and may be incorporated in the linear narrative technology described herein in a relatively straightforward manner.

The model 106 may specify rules, constraints and equations as to how the content is to be synthesized. Alternatively, or in addition to the model 106, the user and/or another source may specify such rules, constraints and equations.

By way of a simple example, consider the beach wedding described above. Rules, provided by a model or any other source, may specify that the content synthesizer 114 create a slideshow of images, which the model divides into categories (ocean, beach and ocean, bridesmaid dresses, ceremony, wedding reception, sunset, hotel), to be shown in that order. From each of these categories, the rules/constraints may specify selecting the six most popular images (according to pervious user clicks) per category, and to show those selected images in groups of three at a time for ten seconds per group. Other rules may specify concepts such as to only show images of bridesmaid's dresses matching those used in the ceremony.

Once the narrative 118 has been synthesized, a narrative playback mechanism 120 plays the linear narrative 118. As with other playback mechanisms, the user may interact to pause, resume, rewind, skip, fast forward and so forth with respect to the playback.

Moreover, as represented in FIG. 1 via block 122, the user may interact to make choices associated with any objects referred to in the presentation of the retrieved content. For example, a user may choose to delete a photograph that is not wanted. A user may delete a category, e.g., do not show bridesmaid dresses. A user may specify other changes to the model parameters, e.g. whether the proposed hotel needs to be replaced with a cheaper hotel alternative. The user may interact with the model, plan objects and/or other data to make choices that are global in nature, or choices that cross multiple objects in the display of the retrieved content, e.g. total number of days of a trip, or total budget.

Whenever the user makes such a change or set of changes, the model 106 may regenerate a new plan, and/or the content synthesizer 114 may generate a new narrative. In this way, a user may perform re-planning based on any changes and/or further choices made by the user, and be presented with a new narrative. The user may compare the before and after plans upon re-planning, such as to see a side by side presentation of each. Various alternative plans may be saved for future reviewing, providing to others for their opinions, and so forth.

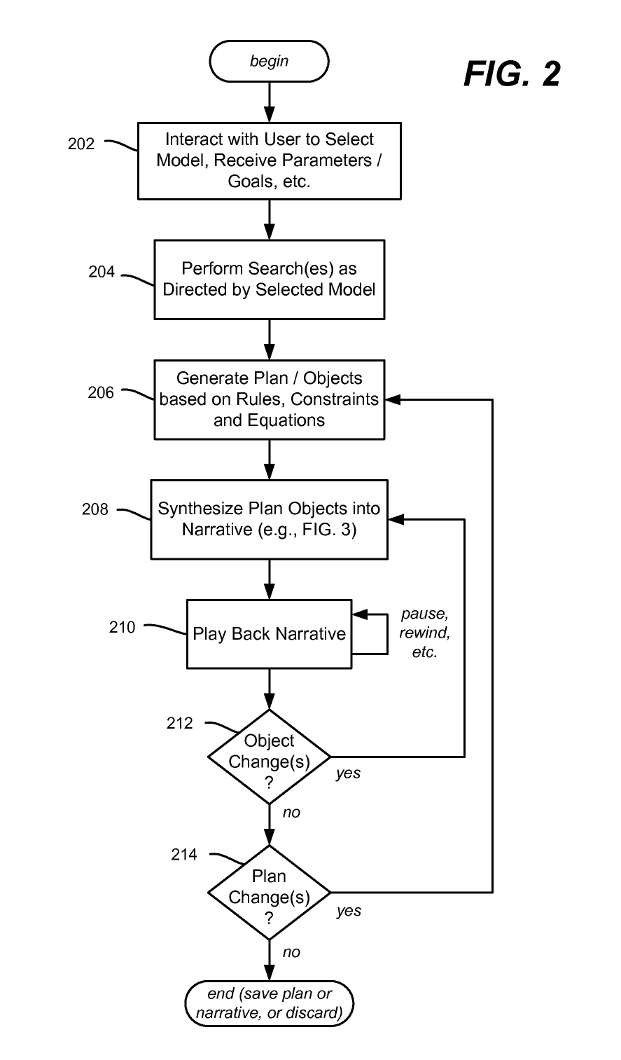

FIG. 2 is an example flow diagram summarizing some of the concepts described above with respect to user interaction and component operations. Step 202 represents a service or the like interacting with a user to select a model and provide it with any relevant data. For example, a user may be presented with a wizard, selection boxes or the like that first determines what the user wants to do, e.g., plan an event, take a virtual tour, and so forth, eventually narrowing down by the user's answer or answers to match a model. For example, a user may select plan an event, then select from a set of possible events, e.g., plan a vacation, plan a wedding, plan a business meeting, and so forth. If the user selects plan a vacation, for example, the user may be asked when and where the vacation is to take place, a theme (skiing, golf, sightseeing, and so on), a budget limit and so forth.

By way of example, consider a user that interacts with a service or the like incorporated into Microsoft Corporation's Bing™ technology for the purpose of making a plan and/or viewing a linear narrative. One of the options with respect to the service may be to select a model, and then input parameters and other data into the selected model (e.g., a location and total budget). With this information, the search for the content may be performed (if not already performed in whole or in part, e.g., based upon the selected model), processed according to the rules, constraints and equations, and provided to the content synthesizer 114. The content synthesizer 114 generates the narrative 118, in a presentation form that may be specified by the model or user selection (play the narrative as a slideshow, or as a combined set of video clips, and so on).

Thus, via step 202, a model may be selected for the user based on the information provided. Further, the user may be presented with a list of such models if more than one applies, e.g., “Low cost Tuscany vacation,” “Five-star Tuscany vacation” and so forth.

Step 204 represents performing one or more searches as directed by the information associated with the model. For example, the above-described beach wedding model may be augmented with information that Hawaii is the desired location for the beach wedding, sunset the desired time, and search for hotels on Western shores of Hawaii, images of Hawaiian beaches taken near those hotels, videos of sunset weddings that took place in Hawaii, and so on. Alternatively, a broader search or set of searches may be performed and then filtered by the model based upon the more specific information.

Once the content is available, step 206 represents generating the plan according to the rules, constraints and equations. For example, the rules may specify a one minute slideshow, followed by a one minute video clip, followed by a closing image, each of which are accompanied by Hawaiian music. A constraint may be a budget, whereby images and videos of very expensive resort hotels are not selected as plan objects.

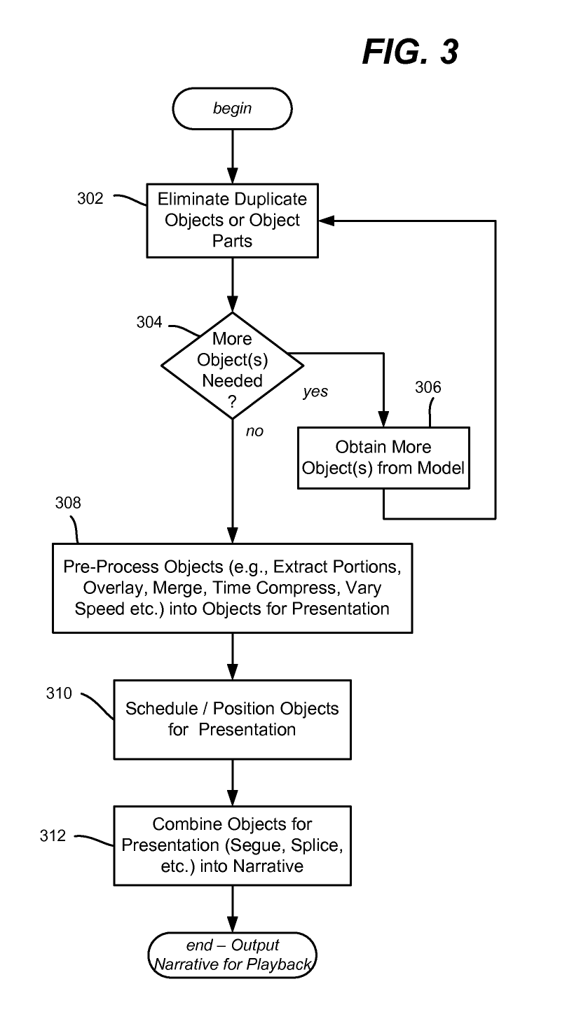

Step 208 represents synthesizing the plan objects into a narrative, as described below with reference to the example flow diagram of FIG. 3. Step 210 plays back the narrative under the control of the user.

As described above, as represented by step 212 the user may make changes to the objects, e.g., remove an image or video and/or category. The user may make one or more such changes. When the changes are submitted (e.g., the user selects “Replay with changes” or the like from a menu), step 212 returns to step 208 where a different set of plan objects may be re-synthesized into a new narrative, and presented to the user at step 210.

The user also may make changes to the plan, as represented via step 214. For example, a user may make a change to previously provided information, e.g., the event location may be changed, whereby a new plan is generated by the model by returning to step 208, and used to synthesize and present a new linear narrative (steps 208 and 210). Note that (although not shown this way in FIG. 2), a user may make both changes to objects and to the plan in the same interaction session, then have the plan regenerated based on both object and plan changes by returning to step 206.

The process continues until the user is done, at which time the user may save or discard the plan/narrative. Note that other options may be available to the user, e.g., an option to compare different narratives with one another, however such options are not shown in FIG. 2 for purposes of brevity.

FIG. 3 represents example operations that the content synthesizer 114 may perform once provided with the plan objects from the model. Step 302 represents the content synthesizer 114 processing the objects to eliminate duplicate (including near-duplicate) objects or object parts. For example, if the model provided two photographs of the same beach a taken few seconds apart, the only difference may be the appearance of the waves in the background. Such too-similar images (relative to a threshold similarity) may be considered near-duplicates and may be removed, such as described in U.S. published patent application no. 20100088295A1.

Step 304 evaluates checking with the model whether there are enough objects remaining after removal of duplicates to meet the model's rules/constraints. For example, the rules may specify that the narrative comprises a slideshow that presents twenty images, whereby after duplicate removal, more images may be needed (obtained via step 306) to meet the rule.

Step 308 is directed towards pre-processing the objects as generally described above. For example, images may be combined with graphics, graphics and/or images may be overlaid onto video, part of an object may be extracted and merged into another object, and so forth. Another possible pre-processing step is to change the object's presentation parameters, e.g., time-compress or speed up/slow down video or audio, for example.

Step 310 represents scheduling and positioning of the objects (in their original form and/or modified according to step 308) for presentation. The order of images in a slideshow is one type of scheduling, however it can be appreciated that a timeline may be specified in the model so as to show slideshow images for possibly different lengths of time, and/or more than one image at the same time in different positions. Audio may be time-coordinated with the presentation of other objects, as may graphic or text overlays, animations and the like positioned over video or images.

Once scheduled and positioned, the objects to be presented are combined into the narrative at step 312. This may include segueing, splicing, and so forth. This may also include special effect transitions or the like, such as described in the aforementioned related U.S. patent application entitled “Using Cinematographic Techniques for Conveying and Interacting with Plan Sagas.”

### Exemplary Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

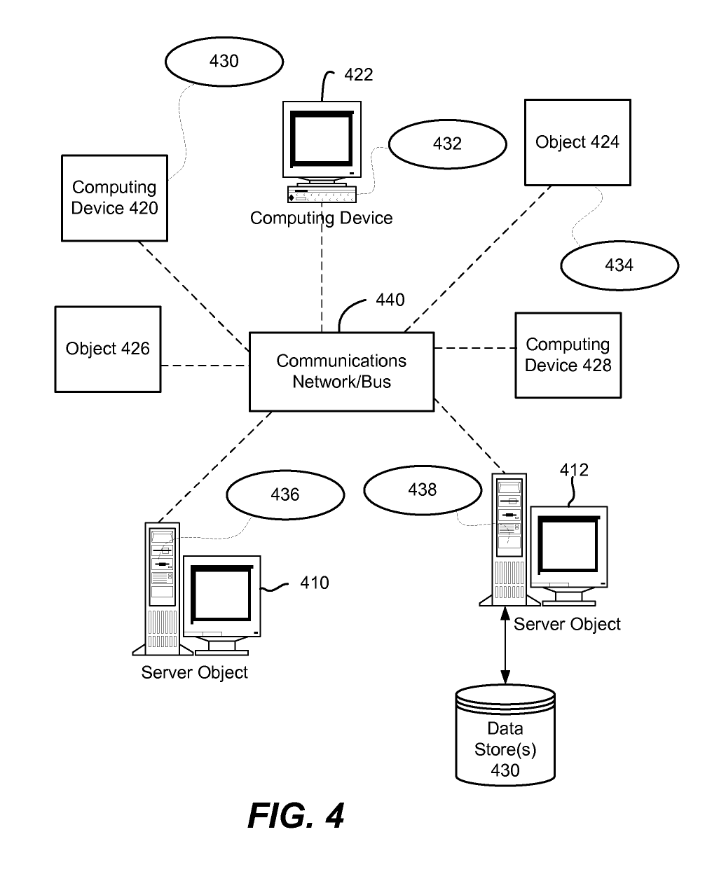

FIG. 4 provides a schematic diagram of an exemplary networked or distributed computing environment. The distributed computing environment comprises computing objects 410, 412, etc., and computing objects or devices 420, 422, 424, 426, 428, etc., which may include programs, methods, data stores, programmable logic, etc. as represented by example applications 430, 432, 434, 436, 438. It can be appreciated that computing objects 410, 412, etc. and computing objects or devices 420, 422, 424, 426, 428, etc. may comprise different devices, such as personal digital assistants (PDAs), audio/video devices, mobile phones, MP3 players, personal computers, laptops, etc.

Each computing object 410, 412, etc. and computing objects or devices 420, 422, 424, 426, 428, etc. can communicate with one or more other computing objects 410, 412, etc. and computing objects or devices 420, 422, 424, 426, 428, etc. by way of the communications network 440, either directly or indirectly. Even though illustrated as a single element in FIG. 4, communications network 440 may comprise other computing objects and computing devices that provide services to the system of FIG. 4, and/or may represent multiple interconnected networks, which are not shown. Each computing object 410, 412, etc. or computing object or device 420, 422, 424, 426, 428, etc. can also contain an application, such as applications 430, 432, 434, 436, 438, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 4, as a non-limiting example, computing objects or devices 420, 422, 424, 426, 428, etc. can be thought of as clients and computing objects 410, 412, etc. can be thought of as servers where computing objects 410, 412, etc., acting as servers provide data services, such as receiving data from client computing objects or devices 420, 422, 424, 426, 428, etc., storing of data, processing of data, transmitting data to client computing objects or devices 420, 422, 424, 426, 428, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 440 or bus is the Internet, for example, the computing objects 410, 412, etc. can be Web servers with which other computing objects or devices 420, 422, 424, 426, 428, etc. communicate via any of a number of known protocols, such as the hypertext transfer protocol (HTTP). Computing objects 410, 412, etc. acting as servers may also serve as clients, e.g., computing objects or devices 420, 422, 424, 426, 428, etc., as may be characteristic of a distributed computing environment.

### Exemplary Computing Device

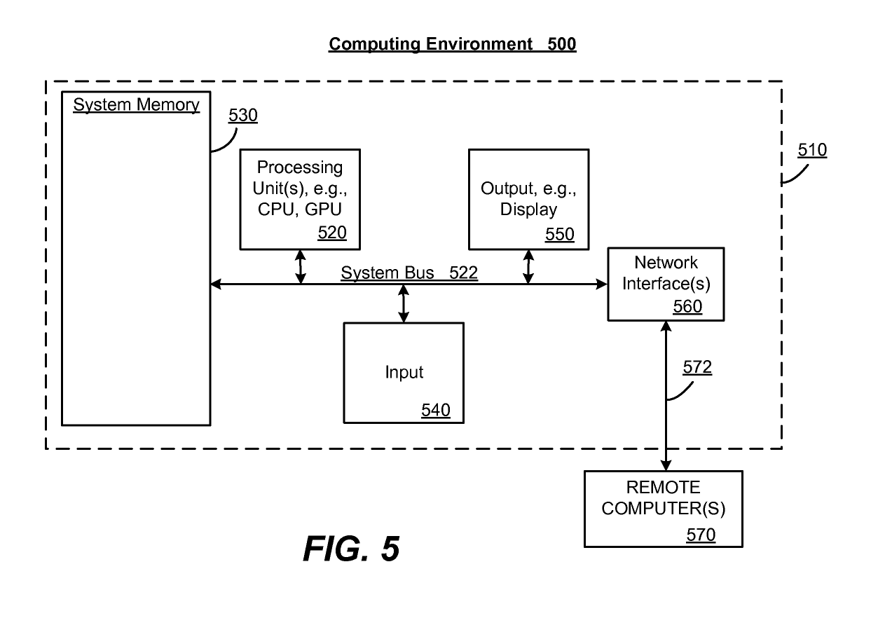

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 5 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 5 thus illustrates an example of a suitable computing system environment 500 in which one or aspects of the embodiments described herein can be implemented, although as made clear above, the computing system environment 500 is only one example of a suitable computing environment and is not intended to suggest any limitation as to scope of use or functionality. In addition, the computing system environment 500 is not intended to be interpreted as having any dependency relating to any one or combination of components illustrated in the exemplary computing system environment 500.

With reference to FIG. 5, an exemplary remote device for implementing one or more embodiments includes a general purpose computing device in the form of a computer 510. Components of computer 510 may include, but are not limited to, a processing unit 520, a system memory 530, and a system bus 522 that couples various system components including the system memory to the processing unit 520.

Computer 510 typically includes a variety of computer readable media and can be any available media that can be accessed by computer 510. The system memory 530 may include computer storage media in the form of volatile and/or nonvolatile memory such as read only memory (ROM) and/or random access memory (RAM). By way of example, and not limitation, system memory 530 may also include an operating system, application programs, other program modules, and program data.

A user can enter commands and information into the computer 510 through input devices 540. A monitor or other type of display device is also connected to the system bus 522 via an interface, such as output interface 550. In addition to a monitor, computers can also include other peripheral output devices such as speakers and a printer, which may be connected through output interface 550.

The computer 510 may operate in a networked or distributed environment using logical connections to one or more other remote computers, such as remote computer 570. The remote computer 570 may be a personal computer, a server, a router, a network PC, a peer device or other common network node, or any other remote media consumption or transmission device, and may include any or all of the elements described above relative to the computer 510. The logical connections depicted in FIG. 5 include a network 572, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a system, comprising:
a search mechanism configured to provide content objects based on a set of one or more searches;
a content synthesizer configured to process at least two of the content objects into a linear narrative; and
a narrative playback mechanism configured to output the linear narrative.

2. The system of claim 1 wherein the content synthesizer is further configured to remove duplicate or near-duplicate object content.

3. The system of claim 1 further comprising a model containing rules, constraints or equations, or any combination of rules, constraints or equations, the model configured to provide information corresponding to the set of one or more searches to the search mechanism, and to generate a plan based upon input information and the rules, constraints or equations, the plan including plan objects corresponding to at least some of the content objects provided by the search mechanism.

4. The system of claim 3 wherein the content synthesizer is further configured to schedule or position, or both schedule and position, the plan objects for synthesizing into the linear narrative.

5. The system of claim 3 wherein the content synthesizer is further configured to process at least one of the plan objects into a modified object for presentation, including extracting a portion of an object, overlaying content of one object over content of another object, revising object presentation parameters, or merging content of two or more objects, or any combination of extracting a portion of an object, overlaying content of one object over content of another object, revising object presentation parameters, or merging two or more objects.

6. The system of claim 1 wherein the content synthesizer is further configured to combine content objects into the linear narrative for presentation.

7. The system of claim 1 wherein the linear narrative includes at least one non-linear narrative portion including at least one branch or alternative.

8. The system of claim 1 wherein the linear narrative includes at least one video clip, or a slideshow comprising at least two images, or both at least one video clip and a slideshow comprising at least two images.

9. The system of claim 1 wherein the linear narrative includes audio played by the playback mechanism in conjunction with visible information played by the playback mechanism.

10. The system of claim 1 wherein the search mechanism and content synthesizer are accessible via a web service

11. The system of claim 1 further comprising an interaction mechanism configured to allow one or more changes to the content objects processed by the content synthesizer, the content synthesizer configured to reprocess at least two of the content objects after the one or more changes into a modified linear narrative.

12. The system of claim 1 further comprising an interaction mechanism configured to allow one or more changes to the input information, the model configured to regenerate a revised plan based upon the one or more changes.

13. In a computing environment, a method performed at least in part on at least one processor, comprising:
performing one or more searches to provide content objects to a model;
generating a plan comprising plan objects chosen from the content objects based on rules, constraints and equations associated with the model;
synthesizing at least some of the plan objects into a linear narrative; and
playing the linear narrative.

14. The method of claim 13 wherein synthesizing at least some of the plan objects into the linear narrative comprises scheduling or positioning, or both schedule and positioning, the plan objects into the linear narrative.

15. The method of claim 13 wherein synthesizing at least some of the plan objects into the linear narrative comprises extracting a portion of an object, overlaying content of one object over content of another object, revising object presentation parameters, or merging content of two or more objects, or any combination of extracting a portion of an object, overlaying content of one object over content of another object, revising object presentation parameters, or merging two or more objects.

16. The method of claim 13 wherein synthesizing at least some of the plan objects into the linear narrative comprises combining content objects into the linear narrative for presentation.

17. The method of claim 13 further comprising, detecting user interaction to receive user input, selecting the model based upon the user input, and providing the model with parameter data based upon at least some of the user input.

18. The method of claim 17 further comprising, detecting user interaction to receive user input corresponding to at least one change to the parameter data, re-generating the plan to include a modified set of plan objects;
and re-synthesizing the modified set plan objects into a modified linear narrative.

19. The method of claim 13 further comprising, detecting user interaction to receive user input, the user input corresponding to at least one change to the plan objects that provides a changed set of plan objects, and re-synthesizing the changed set of plan objects into a modified linear narrative.

20. One or more computer-readable media having computer-executable instructions, which when executed perform steps, comprising,
operating a web service that interacts with a user to assist the user in choosing a model and inputting parameters for that model;
generating a plan based upon the model and the parameters, including obtaining search content comprising plan objects;
synthesizing the plan objects into a linear narrative, and
playing the linear narrative.
